(19) United States
(12) Patent Application Publication
(10) Pub. No.: US 2022/0154527 A1
(43) Pub. Date: May 19, 2022

(54) Rapid sliding roll-up door intended to be interposed between two environments with different temperatures

(71) Applicant: B.PROJET S.r.l., Alba (CN) (IT)

(72) Inventor: Danilo BENOTTO, Montá (CN) (IT)

(21) Appl. No.: 17/530,077

(22) Filed: Nov. 18, 2021

(30) Foreign Application Priority Data
Nov. 18, 2020 (IT) 102020000027621

(51) Int. Cl. E06B 9/58; E06B 9/13

(52) U.S. Cl. CPC E06B 9/58; E06B 9/13

(57) ABSTRACT

A high-speed roll-up door for separating two rooms at different temperatures includes a flexible curtain to close or open a passage of a room separation wall, which passage is delimited, by a portal structure which includes a pair of hollow rails for guiding the curtain. The lateral edges of the curtain have projections for engaging cavities formed between the successive teeth of gear wheels for controlling the movement of the curtain. In the open condition of the door the curtain is received in an upper shelter area axially delimited by two guide panels having specular guide paths. Each guide panel comprises has a seat of a respective gear wheel arranged away from the wall to which the portal structure is associated with, and under the guide panels is prepared a tray for collecting the condensation water present on the curtain, to allow the curtain to be collected entirely above the tray.

### FIELD OF THE DISCLOSURE

The present Invention refers in general to high speed sliding roll-up doors for industrial use, which comprise a flexible curtain intended to be received, in the open condition of the door, in a shelter area located above a portal structure that delimits a passage in a wall that separates two adjacent rooms isolated by the door.

### BACKGROUND OF THE INVENTION

The flexible curtain of known roll-up doors of the type defined above can be wound on a winding shaft arranged above the portal structure on the side closest to the wall in which said opening is formed, which extends into the aforementioned shelter area so as to be parallel to an upper crosspiece of this structure, in this case the curtain, while it is being wound on the winding shaft, is deviated from its vertical path by a transmission shaft parallel to the winding shaft. This known solution is progressively less used because it has the drawback of being relatively complex and expensive to manufacture, and of requiring the use of a mobile counterweight connected to one end of a cable wound up onto the winding shaft of the curtain in order to drag into rotation the winding shaft as a result of the movement of the curtain.

As an alternative to the winding mechanism of the curtain referred to above, and as described for example in WO-2010/101836, the lateral edges of the curtain of a high speed sliding door have a series of equidistant projections intended to be engaged by respective synchronously motorized gear wheels, in order to drag the curtain to move according to its opening and dosing movements of the passage delimited by the portal structure. More specifically, each lateral edge of the curtain is provided with a series of projections which siidingly engage the cavity of a respective vertical guide rail of a respective upright of the portal structure, as well as a guide path which is connected to the upper end of each vertical guide rail and can be spirally shaped Each guide path is formed in a respective end panel which delimits axially the aforementioned shelter area of the curtain, the two guide paths having a symmetrical configuration.

The aforesaid projections of the edges of the curtain also engage cavities interposed between subsequent teeth of the aforesaid gear wheels, so that a rotation of these gear wheels causes the curtain to carry out a downward or upward movement with respect to the portal structure. Since these gear wheels are positioned at the side most adjacent to the wall in which said opening is formed, the curtain, in its condition collected in the shelter area, always has a vertical portion that extends parallel to the guide rails of its lateral edges.

According to another known solution, similar to the one described above, the seats of the gear wheels are formed in the end panels of the shelter area of the curtain and are arranged in the upper part of these panels, at an area adjacent to the wall which the portal structure is associated with. Also in this solution, the guide path formed in each end panel is defined by a groove for sliding the respective lateral edge of the curtain, which includes a vertical portion that extends between a receiving seat of a respective gear wheel and the respective vertical guide rail, in addition to the aforementioned substantially spiral portion for winding the curtain, and a horizontal portion interposed between the seat of the gear wheel and the substantially spiral portion.

More particularly, the invention relates to a roll-up door of the type defined in the preamble of attached claim 1.

In the roll-up door defined above, when the rooms upstream and downstream from the portal structure have a different temperature, for example in the case of a high speed sliding door used to isolate a cold-storage room from the outer environment, the formation of a moisture layer consisting of micro-drops of water or of a film of liquid on the surface of the curtain facing the outer environment at higher temperature is frequent, as a result of the condensation of the water vapor present in the air of this outer environment.

During the raising and winding steps of the curtain in the shelter area, owing to the fact that the aforementioned gear wheels are arranged in a position adjacent to the wall of separation of the two rooms which the portal structure is associated with, there is always a vertical portion of the curtain, so that condensation water associated with this vertical portion of the curtain flows by gravity along the curtain towards its lower transverse edge, causing an annoying fall of water at the portal structure, below the shelter area of the curtain.

### SUMMARY OF THE INVENTION

In order to overcome this drawback, the subject of the invention is a roll-up door having the features mentioned in the attached claims.

According to the invention, each guide panel comprises a receiving seat for receiving a respective gear wheel, which seat is arranged in a part of the respective guide panel remote from the wall to which the portal structure is associated with, and the roll-up door comprises a water collection tray associated beneath said guide panels, whereby the curtain received in said shelter area can be entirely collected, including its lower transverse edge, above said tray so that all condensation water on the curtain can fall by gravity into said tray. This makes it possible to effectively eliminate any possible fall of water under the shelter area of the roll-up door curtain. In particular, the water that accumulates between one coil and the other of the curtain when this is received in the shelter area, as well as in the sliding grooves of the curtain and in the seats of the gear wheels, falls by gravity Into the collection tray, also avoiding a stagnation of water between the coils of the curtain which could cause its damage over time due to moisture, and an obstacle to its uniform sliding along the aforementioned guide paths.

According to a preferred feature of the Invention, each guide path of a respective guide panel comprises a groove for sliding a corresponding lateral edge of the curtain, which groove includes in succession a vertical portion connected to the upper end of a respective guide rail of the portal structure, at least one first downwardly inclined portion and a substantially spiral portion for winding the curtain, said seat for receiving the respective gear wheel being interposed between said at least one first downwardly inclined portion and said substantially spiral portion. In this manner, in the roll-up door of the invention, an accumulation of condensation water between the turns of the curtain wound up in the shelter area and in the seat of the gear wheels is even more effectively avoided.

According to another preferred feature of the invention, the sliding groove of each guide panel comprises a first downwardly inclined portion ending at the respective receiving seat for receiving the gear wheel, and a second downwardly inclined portion interposed between said seat and said substantially spiral portion. The presence of the second downward inclined portion of the sliding groove allows the respective portion of the curtain to be inclined in such a manner as to improve the discharge of condensation water during its winding step in the shelter area.

Preferably, and according to yet another preferred feature of the invention, said first and second downwardly inclined portions of said sliding groove have a different inclination, the second portion being more inclined than the first portion with respect to the horizontal, and extend along respective directions forming an acute angle between them. By virtue of this feature and to the fact that the second downward inclined portion has an inclination greater than the first portion, the condensation water remaining on the curtain after the passage of its edges in the first downward inclined portions of the sliding grooves of the two guide panels, can be drained more efficiently.

### BRIEF DESCRIPTION OF THE DRAWINGS

Further features and advantages of the invention will become dearer from the detailed description below, provided by way of non-limiting example and referred to the attached drawings in which:

FIG. 1 is a schematic perspective view of a roll-up door according to the invention with the curtain thereof in the completely lowered condition in which it closes a passage delimited by a portal structure associated with a wall separating two rooms at different temperatures,

FIG. 2 is an enlarged perspective view of a detail indicated by arrow II in FIG. 1, which corresponds to a faired area for sheltering the curtain, which is arranged above the portal structure,

FIG. 3 is a schematic perspective and exploded view showing the main elements of the fairing of the shelter area of the curtain illustrated in FIG. 2,

FIG. 4 is a view similar to that of FIG. 2, from which a covering element of the fairing of the shelter area has been removed to highlight its inside,

FIG. 5 is another perspective view of the inside of the fairing of the shelter area of the curtain, from the part indicated by arrow V of FIG. 4,

FIG. 6 is an axial elevational view of one of the guide panels arranged at one end of the shelter area of the curtain, in the direction indicated by arrow VI of FIG. 5, in which the lateral edges of the curtain engage a guide groove of the panel, the curtain being in Its condition partially received in the shelter area, and

FIG. 7 is a view similar to FIG. 6, in which the curtain is in its condition fully received in the shelter area.

### DETAILED DESCRIPTION

With reference to the attached Figures, a roll-up door for industrial use according to the Invention is indicated 10 as a whole. The roll-up door 10, of the so-called “high speed sliding” type, allows a rectangular passage 12 to be closed or opened, which is formed in a wall 14 that separates two rooms at different temperatures, for example a cold-storage room from the outer environment. The passage 12 is delimited by a stationary portal structure 16 comprising a pair of vertical uprights 18 opposite each other and provided with respective hollow guide rails 18a, an upper crosspiece 20 and a lower base plane.

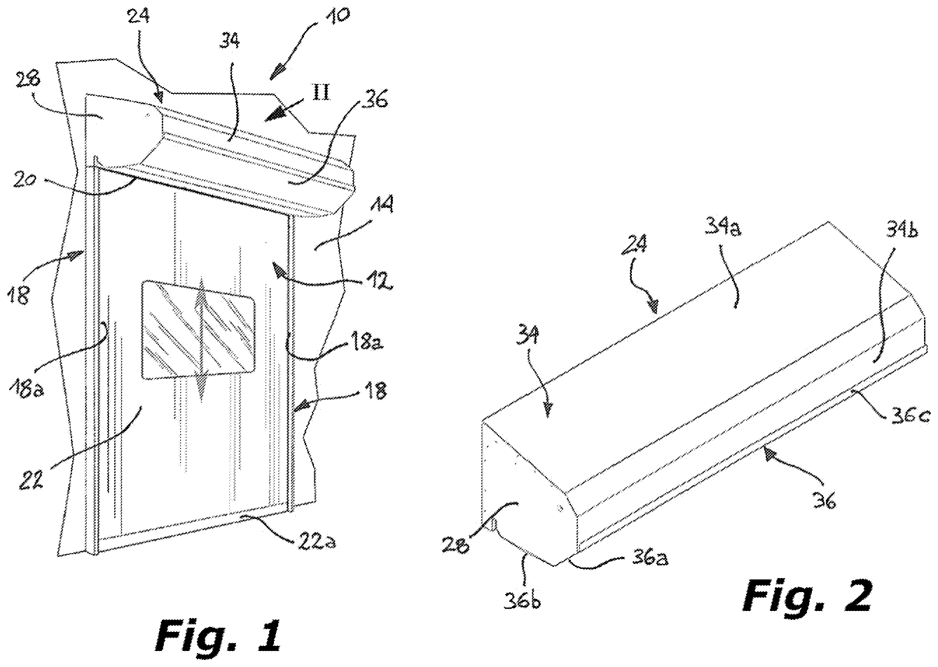

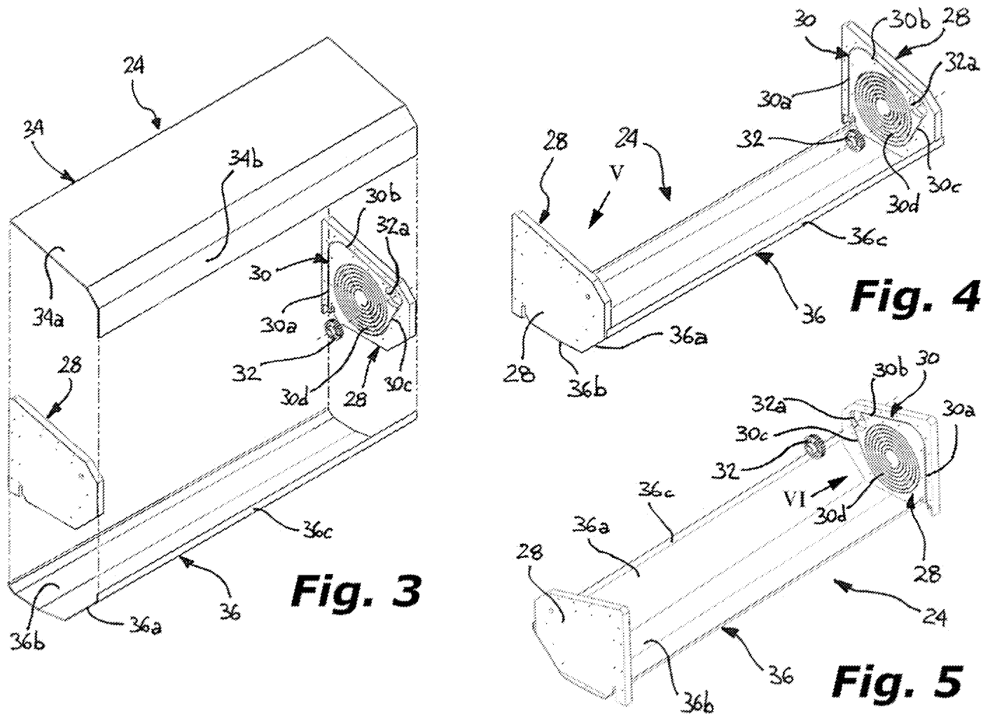

A flexible curtain 22, typically made of plastic material or plasticized textile material, is slidably mounted with respect to the portal structure 16 in order to close or open the passage 12. More particularly, the curtain 22 has opposite lateral edges provided with respective series of equidistant and closely spaced projections 12a, arranged according to the configuration of the teeth of a zipper (see FIG. 5), typically made of substantially rigid plastic material. These projections, the cross section of which substantially corresponds to that of the cavity of the guide rails 18a, slidably engage the cavities of these rails. The curtain 22 comprises a lower terminal edge 22a extending transverse to its sliding direction, which, in its lowered configuration shown in FIG. 1, abuts on the lower base plane of the portal structure 16.

Above the portal structure 16 there is a shelter area of the curtain 22, indicated by reference numeral 24, in which the curtain 22 is stored in its wound up configuration when the door 10 is in its open condition.

The shelter area 24, which is delimited by a protective fairing, extends parallel above the crosspiece 20 and has an axial extension corresponding to the distance between the uprights 18 of the structure 16.

This shelter area 24 is axially delimited by a pair of opposite guide panels 28 arranged transversely to the axis of the area 24, in which respective specular guide paths are formed. Each guide path, which includes a groove 30 for sliding the lateral edges of the curtain 22, is connected to the cavity of the respective rail 18a and has a cross section corresponding to that of the cavity of these rails, so as to allow the projections 12a of the edges of the curtain 22 to slide in them when such edges, as a result of the sliding of the curtain 22, pass from the rails 18a to the shelter area 24. Conveniently, the structure of each guide panel 28 is integrally formed in a single solid block, preferably of plastic material, as a result of a milling machine process.

Each sliding groove 30 formed on a face of the respective panel 28 facing the opposite panel 28, includes in succession a vertical portion 30a, the lower end of which is connected to the upper end of a respective guide rail 18a of the portal structure 16, a short arcuate connecting portion, a downwardly inclined portion 30b ending at a hollow circular seat 32a for accommodating a respective rotatable gear wheel 32 for dragging the projections 12a of the relevant lateral edge of the curtain 22, and a substantially spiral portion 30d for receiving the curtain 22 in the wound up condition. As an alternative to the substantially spiral portion 30d, an elongated rectilinear portion (not shown) of the sliding groove 30, oriented horizontally or vertically, can be used to accommodate almost all of the curtain 22 in the shelter area 24 which, in this case, will be more extended.

In particular, the seat 32a is arranged in the part of the respective panel 18 furthest from the wall 14 and each of the gear wheels 32 has cavities between its teeth the shape of which corresponds to that of the projections 12a, whereby a rotation of the gear wheels 32 in which these projections 12a engage cause descent or rise movement of the curtain 22 with respect to the portal structure 16. Both wheels 32 are connected in rotation to each other in such a manner as to rotate synchronously, for example by means of an axial connecting bar (not shown in the figures) or by another mechanical or electro-mechanical connection mechanism.

Preferably the sliding groove 30 also includes a second portion 30c inclined downwards and interposed between the seat 32a and the substantially spiral portion 30d, having an inclination different and greater than that of the first inclined portion 30b, with respect to the horizontal direction. In particular, the directions of the first inclined portion 30b and of the second inclined portion 30c form an acute angle between them, indicated by α in FIG. 5.

Both guide panels 28 are associated with a cover 34 at the top and a water collection tray 36 at the bottom, which form the aforementioned protective casing together with the panels 28.

The tray 36, in its part arranged substantially below the seats 32a of the gear wheels 32, has a wall 36a inclined upwards so as to convey towards its bottom 36b the water coming from the surface of the curtain 22, and more particularly by the portions of the curtain 22 inclined downwards owing to the presence of the first and second inclined portions 30b and 30c of the groove 30 of the respective guide path.

The inclined wall 36a of the tray 36 outwardly comprises a gutter portion delimited by a vertical edge 36c which extends from the upper edge of the inclined wall 36a.

The cover 34 comprises a top wall 34a inclined downwards in a manner corresponding to that of the first portion 30b of the respective sliding groove 30, and a substantially vertical front wall 34b which ends close to the aforementioned gutter portion at a distance from the inclined wall 36a of the tray 36, to allow the condensation water that could form on the outer side of the cover 34 to reach the bottom 36b of the tray 36.

Furthermore, and according to a constructional modification not shown in the figures, each guide panel 28 can be elastically mounted on a respective stationary support plate (not shown) parallel and fast with said wall 14, to allow the distance of each guide panel 28 to be automatically adjusted against the action of return springs (also not shown), from and towards the respective stationary plate, and therefore from and towards the opposite guide panel 28. In this case, the cover 34 and the collection tray 36 are fixed to such support plates, while the panels 28 are mounted with a possibility of relative movement with respect to the cover 34 and the collection tray 36. This modification allows the tension of the curtain 22 to be adapted during the its winding or unwinding steps in the shelter area 24, in order to reduce the friction generated between the projections 12a of the edges of the curtain 22 and the guide paths 30 of the respective panels 28 during sliding of the curtain 22.

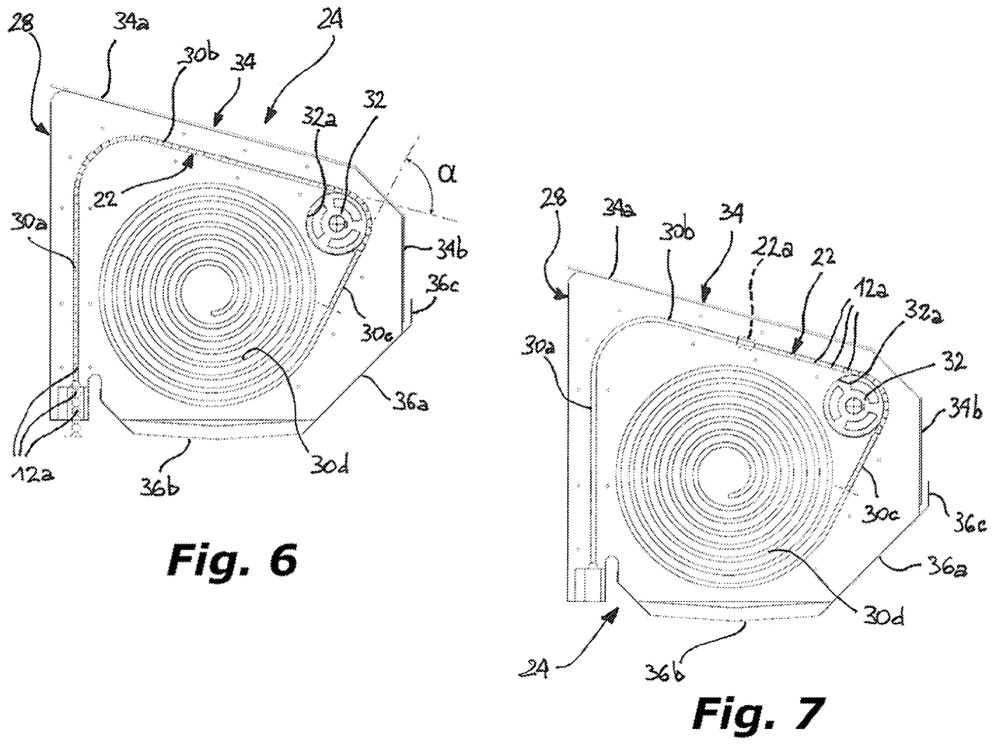

In the operation of the roll-up door 10 of the invention, the curtain 22 is dragged towards its raised condition to open the passage 12 defined by the portal structure 16 (see FIG. 6). In this condition, the curtain 22 is spiral wound in the shelter area 24 as a result of the rotation of the gear wheels 32 in the respective hollow seats 32a of the panels 28, of the engagement of the projections 12a of the lateral edges of the curtain 22 in the cavities of these gear wheels formed between their subsequent teeth, and of the engagement of the lateral edges of the curtain 22 in the sliding grooves 30 formed in the panels 28.

By virtue of the fact that the seats of the gear wheels 32a are arranged in a position well spaced and far from the wall 14 separating the two rooms isolated by the sliding door 10, in the condition of the curtain 22 completely received in the shelter area 24, also the lower transverse edge 22a of the curtain 22 is received inside the shelter area 24, above the tray 36 (see FIG. 7).

If there is condensation water on the surface of the curtain 22, in particular on its surface facing the outer environment when it is in the lowered closing configuration of the passage 12, it falls from the curtain 22 by gravity and accumulates on the bottom 36b of the collection tray 36, in particular owing to the inclination of the inclined portions 30b and 30c of the sliding grooves 30 formed in the panels 28. In particular, possible condensation water still present on the curtain 22 after its edges have passed along the first inclined portion 30b, falls towards the tray 36 as a consequence of the greater inclination of the second inclined portion 30c. Also possible condensation water which may have accumulated along the various portions of the sliding grooves 30 and in the seats 32a of the gear wheels 32, descends by gravity towards the bottom 36b of the tray 36.

Unlike known solutions, in which the curtain 22 always has at least one vertical portion above the portal structure 16, as a consequence of the position close to the wall 14 of the seats 32a of the gear wheels 32, which can cause dripping of the condensation water present on the curtain 22 towards the bottom, by virtue of the invention and to the fact that the seats 32a are well spaced from the wall 14 it is also possible to collect the lower transverse edge 22a of the curtain 22 in the shelter area, in order to avoid the presence of vertical portions of the curtain 22 close to the wall 14 in its completely wound up configuration, and therefore to prevent any dripping of condensation water towards the portal structure 16.

Furthermore, any condensation water present on the outer surface of the cover 34 descends along its outer surface owing to the inclination of its top wall 34a and along its vertical wall 34b, to fall towards the aforementioned gutter portion which extends between the wall 34b of the cover 34 and the vertical edge 36c of the tray 36f to be then deflected by the Inclined wall 36a towards the bottom 36b of the tray 36. In this manner, it is possible to completely avoid dripping of condensation water from the shelter area 24 of the curia in 22 towards the portal structure 16.

At the end of the winding step of the curtain 22, as well as In the subsequent step of unwinding it from the shelter area 24, when it is lowered to close the passage 12 defined by the portal structure 16, the curtain 22 is completely dry, which allows its damage over time due to humidity to be avoided, and therefore to extend its service life

1: A high speed sliding roll-up door for separating two rooms at different temperatures, comprising a flexible curtain to close or open a passage formed in a separation wall for separating said rooms, which passage is delimited by a portal structure including a pair of side uprights provided with hollow rails for guiding the curtain and an upper crosspiece, the side edges of the curtain being provided with a series of projections the cross-section of which substantially corresponds to that of the cavity of said guide rails, which projections are adapted to engage cavities formed between subsequent teeth of respective gear wheels for controlling movement of the curtain, the curtain being configured to be received above the portal structure, in the open condition of the door, in a shelter area delimited at the opposite axial ends by a pair of specular guide paths formed in respective guide panels,
wherein each guide panel comprises a receiving seat for receiving a respective gear wheel, which seat is arranged in a part of the respective guide panel remote from the wall which the portal structure is associated with, and in that the portal structure comprises a water collection tray associated beneath said guide panels, whereby the curtain received in said shelter area can he entirely collected, including its lower transverse edge, above said tray so that all condensation water on the curtain can fall by gravity into said tray.

2: The roll-up door according to claim 1, wherein each guide path of a respective guide panel comprises a groove for sliding a corresponding lateral edge of the curtain, which groove includes in succession a vertical portion connected to the upper end of a respective guide rail of the portal structure, at least one first downwardly inclined portion and a substantially spiral portion for winding the curtain, said receiving seat for receiving the respective gear wheel being interposed between said at least one first downwardly inclined portion and said substantially spiral portion.

3: The roll-up door according to claim 2, wherein said sliding groove of each guide panel comprises a first downwardly inclined portion ending at the respective receiving seat for receiving the gear wheel, and a second downwardly inclined portion interposed between said seat and said substantially spiral portion.

4: The roll-up door according to claim 3, wherein said first and second downward inclined portions of said sliding groove have a different inclination, the second portion being more inclined than the first portion with respect to the horizontal, and extend along respective directions forming an acute angle between them.

5: The roll-up door according to claim 3, wherein the water collection tray has, beneath said receiving scats for receiving the gear wheels, a wall inclined upwards to direct towards its bottom the water coming from the portions of the curtain which are inclined downwards as a result of the presence of said first and second inclined portions of the sliding groove.

6: The roll-up door according to claim 5, wherein said upwardly inclined wall of the water collection tray comprises outwardly a gutter portion delimited by a vertical edge.

7: The roll-up door according to claim 6, wherein said shelter area for receiving the curtain is provided with an upper cover comprising a top wall inclined downwards in a manner substantially corresponding to said first portion of the sliding groove of each panel, and a substantially vertical front wall ending close to said gutter portion, at a distance from said wall inclined upwards of said tray.

8: The roll-up door according to claim 7, wherein each guide panel is supported by a respective stationary support plate fast with said wall with a possibility of relative elastic movement to and from the respective support plate against the action of return springs, to allow the distance between said guide panels to be automatically adjusted, said upper cover and said water collection tray being connected to said stationary support plates, the guide panels being mounted with a possibility of relative movement with respect to said upper cover and said tray.

9: The roll-up door according to claim 4, wherein the water collection tray has, beneath said receiving seats for receiving the gear wheels, a wall inclined upwards to direct towards its bottom the water coming from the portions of the curtain which are inclined downwards as a result of the presence of said first and second inclined portions of the sliding groove.

10: The roll-up door according to claim 9, wherein said upwardly inclined wall of the water collection tray comprises outwardly a gutter portion delimited by a vertical edge.

11: The roll-up door according to claim 10, wherein said shelter area for receiving the curtain is provided with an upper cover comprising a top wall inclined downwards in a manner substantially corresponding to said first portion of the sliding groove of each panel, and a substantially vertical front wall ending close to said gutter portion, at a distance from said wall inclined upwards of said tray.

12: The roll-up door according to claim 11, wherein each guide panel is supported by a respective stationary support plate fast with said wall with a possibility of relative elastic movement to and from the respective support plate against the action of return springs, to allow the distance between said guide panels to be automatically adjusted, said upper cover and said water collection tray being connected to said stationary support plates, the guide panels being mounted with a possibility of relative movement with respect to said upper cover and said tray.
